(19) United States
(12) Patent Application Publication
(10) Pub. No.: US 2017/0339989 A1
(43) Pub. Date: Nov. 30, 2017

(54) MEAT AND METHODS OF PREPARING SAME HAVING REDUCED SODIUM CONTENT

(71) Applicant: COLORADO STATE UNIVERSITY RESEARCH FOUNDATION, Fort Collins, CO (US)

(72) Inventors: Dale Woerner, Greeley, CO (US); Keith Belk, Fort Collins, CO (US); Dan Sewald, Kiowa, CO (US); Gary Sisney, Windsor, CO (US)

(21) Appl. No.: 15/607,843

(22) Filed: May 30, 2017

Related U.S. Application Data
(60) Provisional application No. 62/343,520, filed on May 31, 2016.

(51) Int. Cl. A23L 13/00; A23L 13/40

(52) U.S. Cl. CPC A23L 13/00; A23L 13/40; A23V 2002/00

(57) ABSTRACT

Methods of producing meat compositions with reduced salt content are provided. The process includes providing meat pieces which are bound by cold-binding agents, and in which no salt or reduced salt amounts are added to the meat pieces. The process reduces time and equipment for preparation of the meat to process the meat and extract and bind protein.

### CROSS-REFERENCE TO RELATED APPLICATION

The present application claims priority to previously filed and co-pending application U.S. Ser. No. 62/343,520 filed May 31, 2016, the contents of which are incorporated herein by reference in their entirety.

### BACKGROUND

Meats have been preserved and flavored by a curing process, where salt, sugar and other ingredients are added, which may include either nitrate or nitrites. In meats, salt serves as the predominant flavoring agent and preservative. Sugar/sweeteners also provide flavor and preservation properties in processed meat products, Sources of nitrite in meat formulations provide an antimicrobial effect, serve as an antioxidant, and contribute to color development in cured meats. See, e.g., Science of Cooking, http://www.scienceofcooking.com/curing_foods.htm; McGee, Harold, On Food and Cooking (revised) New York, N.Y.: Scribner 2004.

In addition to salt serving as a preservative and flavoring agent, the addition of salt to meat allows for the extraction of salt-soluble, heat coagulable proteins and allows for the bonding or binding of meat and meat pieces. In order to effectively bond meat together using salt, significant levels of salt must be used and a heating/cooking step is required. Meat and meat pieces can be bonded together without the addition of salt and heat using cold bonding agents, but these agents have not been used to produce sodium-free or reduced sodium processed meat products. Cold bonding involves the utilization of cold bonding agents (e.g. fibrinogen, transglutaminase, sodium alginate, etc.) with raw meat pieces to form a single, cohesive unit of meat. Cold bonded meat items have integrity in raw form and can be sold in raw form to be father cooked and prepared. In one example transglutaminase is used with salt at a level of at least 1.5% to produce a restructured raw meat product. See Moller et al., U.S. Pat. No. 5,686,124. In another example, cold-bind restructured meat is tenderized using a process described by Sheehy et al. in U.S. Pat. No. 6,221,405.

### SUMMARY

The current method produces a meat composition, a processed meat product, which has reduced, or no salt content, where mechanical agitation, messaging, and/or tumbling is not required for protein extraction, and a heating step is not required for complete bind or bonding. In comparison to current, conventional manufacturing practices, this method allows for processed meat items, cured or uncured, to be produced with significantly reduced sodium content in a reduced amount of time contributing to lower labor and equipment costs. An embodiment of the invention provides the raw meat or meat pieces are combined and the surface contacted with a cold-binding agent, such as fibrinogen, thrombin, transglutaminase, sodium alginate or combination thereof, or other cold-binding agent. No salt needs to be added for extraction of the proteins of the meat, and binding of the meat proteins occurs in the absence of massaging or agitation. Meat proteins bind in the absence of heat or salt.

### DETAILED DESCRIPTION

The present process uses a unique method in which a processed meat product is produced with zero or reduced levels of salt. Processed meats are meats modified from their original muscle form. In an example, processed meats may be cured or uncured. Processed meats include those meats that have been modified to change texture, taste or shelf life. To conventionally produce a processed meat item (cured or uncured), salt is required for functionality, flavor, and preservation. In addition to salt, other ingredients may be added, including but not limited to, water, sugar, phosphate, nitrate or nitrate, and coloring and flavoring agents. Specifically, in conventional processes, significant levels of salt and heat are required to extract protein in order to bond or bind meat pieces together. Here, the process combines or bonds pieces of meat, which may for example be cut, and may be ground, comminuted, chopped, minced or emulsified, using a cold-binging agent without the addition of salt and/or heat. A cold-binding agent is one which binds together meat pieces without the extraction of salt soluble, heat coagulable proteins and without the application of heat.

Cold-binding has been used to bind together sections of meat muscle to create a whole raw meat product into a desired shape, using separate muscles to create a uniform mass. The muscles are combined to produce a desirable consumer muscle mass, whereas the addition of additional ingredients for the purpose of curing is a separate step. In one example of cold-binding uses, external fat may be removed from a muscle and bonded back together to form a product that appears as a single, whole muscle product. In another example, the manipulation and bonding of beef tenderloin to increase its size and desirability as beef filets and/or as beef porterhouse steaks is used. Still another example is combining portions of small or irregular pieces of meat into a single portion that may have a better appeal and yield for the consumer. See, e.g., U.S. Pat. No. 6,221,405.

In the present process, cold-binding agents are utilized to prepare processed meat products, but one which has lower or no salt content. In a typical curing method, sodium in the form of sodium chloride ranging from 1.0% to at least 3% or more by weight to effectively bond, flavor, and preserve the product. See U.S. Pat. No. 5,686,124; Principals of meat technology, www.fao.org/docrep/010/ai407e/ai407e04.htm. and Romero et al. Meat Science 84, 747-754 (2010). Here, a processed meat product and/or a bound meat product is produced which in an example has less than 5%, 4%, 3%, 2%, 1.5%, 1% salt content by weight or amount in-between or may have no added salt.

The cold-binding agents are placed in contact with the meat, in whatever form is most convenient. The cold-binding agents may be provided, for example, as a powder, slurry or any other convenient method to the surface of the meat. The meat is contacted with the agents for a period as indicated by the manufacturer of the agents, and in one embodiment is contacted with the meat at 0° to 4° C. for six to 24 hours. Cold-binding agents which are currently known and will be developed may be used in the present system. An example is fibrinogen and thrombin, plasma components that when combined, produce fibrin that binds meat tissue. When referring here to fibrin as a cold-binding agent is also intended to include where the meat is contacted with fibrinogen and thrombin to result in fibrin formation. Examples include porcine or bovine fibrinogen, and one example is FIBRIMEX® which is typically applied at 0.05% to 7.0% by weight of the meat to be bonded. Transglutaminase is another example of a cold-binding agent, and one example is ACTIVA® which is typically applied at no greater than 0.65 ppm of meat to be bonded. Still another example is sodium alginate, in which calcium may be optionally added to prevent pre-gelation. The meat is held at varying temperatures, depending upon the system used, and can include holding the meat and binder at 0° to 4° C. for 90 minutes to 48 hours. Though it can be held at higher temperatures, generally temperatures below 4° C. are preferable to reduce the opportunity for microorganism growth. Here, in a preferred embodiment, the meat is contacted with the cold-binding agent and optionally placed into a desired shape or form. It may go directly to cooking or the treated meat can wait until the bonding agents have bound and then go into a cook cycle. In general, the cold-binding agent is contacted with the meat for a period of time that allows the meat to adhere or the cooking process accelerates the bonding process thus reducing processing time.

Utilizing cold-binding technologies to achieve protein bonding allows for added salt to be eliminated from or reduced in formulations and sodium content is thereby drastically reduced in finished meat products. Instead, salt and salt substitutes may be added only as desired for flavoring the product. Without the need of agitation for protein extraction, there is reduced time for preparing a cured meat and reduced cost in that the lengthy agitation is not required. When using a salt process to preserve meat, it is necessary to massage or otherwise agitate the meat for at least 45 minutes to four hours or more. When referring to agitation of the meat is meant to include any available methods of incorporating a substance into the meat and/or extracting proteins by physical or mechanical means, including massage, tumbling or vacuum tumbling or mixing. Here, no agitation is needed for extracting protein via the addition of salt or other ingredients intended to enhance protein extraction. Instead, the only agitation optionally utilized is that which is desired for adding ingredients and distributing them in the meat. In an example, salt may be provided in an enhancement solution, which can optionally incorporate other flavoring ingredients, and need only be massaged or agitated for about ten to 15 minutes. Vacuum tumbling may be utilized to assist in incorporating the enhancement solution into the meat.

In an embodiment, the meat may be placed in a form such as a mold, casing or other encasement that forms the meat into a desired shape.

Bonding meat products with salt also requires a heating step which is not necessary with the present method. Instead, the inventors have found the meat is bound and preserved using the cold-binding agents without the addition of heat.

The meat that may be utilized in the present process is from beef, pork, poultry, fish, or any other terrestrial or aquatic species. The process is useful for preparing ready to eat deli products, which are the result of combination of chopped or finely chopped or emulsified meats. In one example, a composite meat product is produced where the desired end product contains a reduction of sodium, labor and equipment to make a low sodium ham and deli loaves. The meat product produced in one embodiment is a boneless deli loaf or ham. The ham may be formed from multiple meat pieces. A deli loaf refers to a precooked or cured meat product that is a composition of meat pieces bound together into a mass and formed into a desired shape by pressing into a mold or casing or the like and is often sliced before eating. These items may also be referred to as chunked and formed or sectioned and formed meat products. As desired, the deli loaves or hams are produced in a manner that offers a natural ham and deli loaf appearance and taste while reducing the sodium content and reducing cost in labor and equipment needed to produce it. The processes also relate to a method for manufacturing product that has the appearance, taste, texture and attributes of traditional deli loaves and hams.

The result is a processed meat product which has reduced salt content compared to a method using sodium for preservation and/or bonding. In certain embodiments, no sodium is added. In other embodiments, a reduced amount of sodium is added for flavoring. The meat is produced in a shorter time and at lower cost that sodium bound and/or preserved meats. Embodiments provide for no agitation of the meat, or agitate to incorporate flavoring agents for less than 45 minutes, for example, for 1, 2, 3, 4, 5, 6, 7, 8, 9, 10, 11, 12, 13, 14, 15 minutes or more up to 45 minutes. The reduction in time is at least ⅓, ½, twice as much, three times four times, five times, ten times, 15 times, 16 times or more compared to the 45 minutes to four hours necessary when using increased salt. An embodiment of the invention provides no labor or mechanical device is necessary for agitation, or that such labor of mechanical agitation is reduced compared to a process for producing a meat product that does not use the present process. In one example, a 200-lb vacuum tumbler can cost approximately $9,000, which can be reduced to zero when not needed. Alternatively, a vacuum tumbler can be used for much shorter periods of time for incorporating flavoring ingredients only, and smaller models used.

The following is presented by way of illustration and is not intended to be limiting to the scope of the invention. All references cited herein are incorporated herein by reference in their entirety.

### EXAMPLES

### Example 1

Here it is shown that meat cold-binding technologies (e.g., fibrin, transglutaminase, sodium alginate, etc.) can be utilized to significantly expedite the process of manufacturing processed meat products that require added salt, heat, and protein extraction to achieve the bonding of proteins, and the amount of equipment and manpower required may also be reduced. Additionally, utilizing cold-binding technologies to achieve protein bonding allows for added salt to be eliminated from or reduced in formulations and sodium content is thereby drastically reduced in finished meat products. This process can be applied to any and all products utilizing animal proteins (i.e., meat, poultry, and fish). This process can be used in brined, already cured, and uncured meat, poultry, and fish products.

Salt (NaCl) serves as the primary ingredient responsible for functionality and flavor development in traditionally processed meat and poultry products. Specifically, salt is required to extract protein in these products which is required to achieve “bind” in restructured and/or formed meat products. A consequence of using sodium-salts for processing meat, poultry, and fish products is that there is a large amount of sodium added to the finished products. Reducing or even eliminating salt in product formulation while maintaining the ability to bind meat products together, creates the opportunity to manufacture reduced sodium products without a loss in functionality. Additionally, in order to manufacture restructured and/or formed meat products, a significant amount of mechanical agitation (tumbling or massaging) is required to extract proteins in order to achieve bind. This process is time intensive, and eliminating or reducing this processing step would result in significant time and cost savings for the manufacturer, and may allow for the removal of equipment in the manufacturing facility for additional cost and space saving.

In an embodiment of the invention the process may include a) providing raw meat pieces: b) optionally injection or vacuum tumbling the marinade into said muscles until desired amount of flavoring is achieved; c) mixing the cold-binding agent such as pork or beef fibrin or transglutaminase and topically applying to coat all muscles surfaces; d) optionally' forming desired shape of composite into an enclosure such as but not limited to molds, casings, netting, containers or vacuum bags; e) optionally maintaining the desired shape at least until adjoining meat pieces have become bonded together or straight to the cooking; f) providing the resulting meat product tor consumption, or optionally but not necessarily cooking the composite to a desired temperature; and g) optionally refrigerating the composite per normal industry standards.

The inventors have successfully manufactured reduced sodium, formed, and restructured meat products using this process. The inventors have utilized this process to manufacture formed and restructured meat product with zero added salt and with no mechanical agitation. The products created exhibited the desired characteristics of a conventionally processed product, including appearance, functionality (bind), and flavor.

One example of the products that were developed is a boneless, formed cured ham manufactured using cold-binding agents with zero added salt. The ham was created using the following process steps:
1) obtain fresh raw materials (i.e., fresh pork hams);
2) apply desired brine and/or seasoning agents ((i.e., ham brine with 0.5% NaCl (w/w in finished product), 0.5% KCl (w/w in finished product), water, phosphate, and nitrite)) using needle injection;
3) apply cold-binding ingredients to surfaces of product (i.e., fibrin @ 5% of product weight);
4) net or bag product to apply pressure and allow for product contact and bonding;
5) cook product using standard cook cycle.
   The resulting finished product contains 25% of added NaCl of traditional product (i.e., ham with target 2% NaCl in finished product).

### Example 2

Cook-in-Bag Poultry Deli Loaf 0% Salt consists of 4536 grams of boneless skinless chicken breast with rib meat. The loaf was prepared as follows.

Whole chicken breasts were cut into approximately 1 inch square pieces by processing with a Hobart grinder model # 4632 with a kidney plate using a single pass.

Chicken was marinated with a 16% by weight (726.11 grams) brine consisting of 713 grams of water, 10.35 grams of dextrose and 2.76 phosphate.

Marinade and chicken were placed into a Lance vacuum tumbler model # LT5 with 24 bars of vacuum pulled for 15 minutes at 15 RPM.

Marinated chicken was combined with a solution of 6.0% by weight (317.515 grams) of bovine fibrinogen plus (31.75 grams) of bovine thrombin and thoroughly mixed.

Combined meat mixture was placed into 5-inch cook-in-bags and sealed by clipping using a pneumatic Tipper Tie press.

### Example 3

Cook-in-Bag Poultry Deli Loaf 2.0% Salt consists of 4536 grams of boneless skinless chicken breast with rib meat. The product was prepared as follows.

Whole chicken breasts were cut into approximately 1 inch square pieces by processing with a Hobart grinder model # 4632 with a kidney plate using a single pass.

Chicken was marinated with a 16% by weight (726.71 grams) brine consisting of 686 grams of water, 27.60 grams of salt, 10.35 grams of dextrose and 2.76 phosphate.

Marinate and chicken were placed into a Lance vacuum tumbler model # LTS with 24 bars of vacuum pulled for 15 minutes at 15 RPM.

Marinated chicken was combined with a solution of 6.0% by weight (317.515 grams) of bovine fibrinogen plus (31.75 grams) of bovine thrombin and thoroughly mixed. Combined meat mixture was placed into 5-inch cook-in-bags and sealed by clipping using a pneumatic Tipper Tie press.

### Example 4

Cook-in-Bag Poultry Deli Loaf 3.0% Salt consists of 4536 grams of boneless skinless chicken breast with rib meat. The product was prepared as follows,

Whole chicken breasts were cut into approximately 1 inch square pieces by processing with a Hobart grinder model # 4632 with a kidney plate using a single pass.

Chicken was marinated with a 16% by weight (726.71 grams) brine consisting of 672 grams of water, 41.40 grams of salt, 10.35 grams of dextrose and 2.76 phosphate.

Marinate and chicken were placed into a Lance vacuum tumbler model # LTS with 24 bars of vacuum pulled for 15 minutes at 15 RPM.

Marinated chicken was combined with a solution of 6.0% by weight (317.515 grams) of bovine fibrinogen plus (31.75 grams) of bovine thrombin and thoroughly mixed.

Combined meat mixture was placed into 5-inch cook-in-bags and sealed by clipping using a pneumatic Tipper Tie press.

### Example 5

Cook-in-Bag Roast Beef 0% salt added, consists of 4536 grams of bovine bottom round flat fabricated at Colorado State University Meat Science Lab and were prepared as follows.

Whole trimmed bottom round flats were cut into approximately 1 inch square pieces by processing with a Hobart grinder model # 4632 with a kidney plate using a single pass.

Bottom round flats were marinated with a 16% by weight (726.21 grams) brine consisting of 720 grams of water, 3.45 grams of dextrose and 2.76 phosphate. Marinate and beef were placed into a Lance vacuum tumbler model # LT5 with 24 bars of vacuum pulled for 15 minutes at 15 RPM.

Marinated beef was combined with a solution of 6.0% by weight (317.515 grams) of bovine fibrinogen plus (31.75 grams) of bovine thrombin and thoroughly mixed.

Combined meat mixture was placed into 5-inch cook-in-bags and sealed by clipping using a pneumatic Tipper Tie press.

Example 6

Cook-in-Bag Roast Beef 2.0% salt added, consists of 4536 grams of bovine bottom round flat fabricated at Colorado State University Meat Science Lab and were prepared as follows.

Whole trimmed bottom round flats were cut into approximately 1 inch square pieces by processing with a Hobart grinder model # 4632 with a kidney plate using a single pass.

Bottom round flats were marinated with a 16% by weight (726.21 grams) brine consisting of 693 grams of water, 27.60 grams of salt, 3.45 grams of dextrose and 2.76 phosphate.

Marinade and beef were placed into a Lance vacuum tumbler model # LT5 with 24 bars of vacuum pulled for 15 minutes at 15 RPM.

Marinated beef was combined with a solution of 6.0% by weight (317.515 grams) of bovine fibrinogen plus (31.75 grams) of bovine thrombin and thoroughly mixed.

Combined meat mixture was placed into 5-inch cook-in-bags and sealed by clipping using a pneumatic Tipper Tie press.

### Example 7

Cook-in-Bag Roast Beef 3.0% salt added, consists of 4536 grams of bovine bottom round flat fabricated at Colorado State University Meat Science Lab and were prepared as follows.

Whole trimmed bottom round flats were cut into approximately 1 inch square pieces by processing with a Hobart grinder model # 4632 with a kidney plate using a single pass.

Bottom round flats were marinated with a 16% by weight (726.61 grams) brine consisting of 679 grams of water, 41.40 of salt, 3.45 grams of dextrose and 2.76 phosphate,

Marinade and beef were placed into a Lance vacuum tumbler model # LT5 with 24 bars of vacuum pulled for 15 minutes at 15 RPM.

Marinated beef was combined with a solution of 6.0% by weight (317.515 grams) of bovine fibrinogen plus (31.75 grams) of bovine thrombin and thoroughly mixed.

Combined meat mixture was placed into 5-inch cook-in-bags and sealed by clipping using a pneumatic Tipper Tie press.

The methods as above are followed, where transglutaminase is substituted for fibrinogen and thrombin.

### Example 9

The methods as above are followed, wherein there is no added salt and no agitation of the meat.

What is claimed is:

1. A method of producing a reduced sodium formed meat composition, comprising,
a) processing meat by chopping, grinding, comminuting, mincing or emulsifying meat;
b) contacting said processed meat with at least one cold-binding agent under conditions that cause said cold-binding agent to bind said processed meat;
c) forming said meat into a desired shape;
d) said method adding no salt up to less than 5% salt by weight of said meat;
e) said meat subject to no agitation up to no more than fifteen minutes' agitation; and
f) producing a formed meat composition having less than 5% salt by weight of said meat.

2. A method of producing a meat composition having reduced sodium content, the method comprising,
a) providing more than one piece of meat;
b) contacting said more than one piece of meat with at least one cold-binding agent under conditions that cause said cold-binding agent to bind said meat pieces;
c) said method adding no salt up to less than 5% salt by weight of said meat; and
d) producing a meat composition that has less than 5% salt content by weight.

3. The method of claim 2, wherein 3% or less sodium is added to said more than one piece of meat.

4. The method of claim 2, wherein 1.5% or less sodium is added to said more than one piece of meat.

5. The method of claim 2, wherein 1.0% or less sodium is added to said more than one piece of meat.

6. The method of claim 2, in which no salt is added to said more than one piece of meat.

7. The method of claim 2, wherein said cold-binding agent is selected from fibrin, transglutaminase or sodium alginate or a combination thereof.

8. The method of claim 2, further comprising contacting said more than one meat piece with a flavoring composition comprising less than 5% salt.

9. The method of claim 2, wherein said more than one piece of meat is subjected to no agitation up to no more than fifteen minutes of agitation.

10. The method of claim 2, wherein said more than one piece of meat comprises chopped or ground, comminuted, minced or emulsified meat pieces.

11. The method of claim 10 further comprising forming said meat into a desired shape.

12. The method of claim 2, wherein said composite meat composition is a ham.

13. The method of claim 2, wherein said meat composition comprises beef.

14. The method of claim 2, wherein said meat composition comprises a deli loaf.

15. The method of claim 2, further comprising contacting said more than one piece of meat with a flavoring composition such that said more than one piece of meat is not agitated or is agitated for more than fifteen minutes, and wherein said at least one cold-binding agent is selected from fibrin, transglutaminase or sodium alginate or a combination thereof.

16. A method of reducing cost and/or time of producing a meat composition, the method comprising,
a) providing more than one piece of meat;
b) contacting said more than one piece of meat with a cold-binding agent under conditions that cause said more than one piece of meat to bind;
c) said method adding no salt up to less than 5% salt by weight of said meat; and
d) producing a composite meat composition that has less than 5% salt content by weight,
wherein said meat composition is produced without agitation of said more than one meat pieces or up to no more than fifteen minutes of agitation of said meat pieces, thereby reducing cost and/or time to produce said meat composition compared to a process which adds more than 5% salt and in which said more than one meat piece is agitated for more than fifteen minutes.

17. The method of claim 16, wherein said more than one meat piece is not agitated.

18. The method of claim 16, wherein time of producing said meat composition is reduced by at least one-third.

19. The method of claim 16, wherein no salt is added to said more than one piece of meat and is not agitated.

20. The method of claim 16, wherein a flavoring composition is contacted with said more than one piece of meat and said more than one piece of meat is agitated with said flavoring composition for no more than fifteen minutes.
